(19) United States
(12) Patent Application Publication
(10) Pub. No.: US 2009/0285545 A1
(43) Pub. Date: Nov. 19, 2009

(54) INTELLIGENT PAUSE BUTTON

(75) Inventor: Bjorn J.M. Bon, Helmond (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,850

(22) PCT Filed: Dec. 5, 2005
(86) PCT No.: PCT/IB05/54053

§ 371 Date: Jun. 5, 2007

Related U.S. Application Data
(60) Provisional application No. 60/633,975, filed on Dec. 7, 2004.

(51) Int. Cl. H04N 5/91; G08B 23/00

(52) U.S. Cl. 386/68; 340/573.1; 386/E05.001

(57) ABSTRACT

A system (10) includes a playback device (30) configured to display content on a display. A detector (40) detects a first number of viewers in a viewing area, and a controller (60) generates a control signal to pause the playback device (30) when a reduced number of viewers is detected by the detector (40). The controller (60) generates a further control signal to resume playback of the playback device (30) in response to detecting the number of viewers in the viewing area by the detector (40). The playback device (30) is rewound for a predetermined time in response to the control signal prior to the pause.

The present invention relates generally to intelligently pausing and playing content, such as video content for viewing.

There are many systems that include intelligent media players, such as one disclosed in U.S. 2002/0174426 A1 to Gutta et al., assigned to Koninklijke Philips Electronics N.V., which is incorporated herein by reference in its entirety. Known intelligent media players include a camera and processor to capture and identify viewers, and based on the profile of the identified viewer(s) and predefined rules, the intelligent system performs predetermined functions, such as turning on or off the media player. Cameras and recognition systems are typically used for detecting and identifying viewers as disclosed in U.S. Pat. No. 6,674,458 B1 to Cohan-Solal et al., and U.S. 2004/0003392 A1 to Gutta et al., both assigned to Koninklijke Philips Electronics N.V., which are incorporated herein by reference in their entirety.

There is a need for an improved smart system that easily determines the number of viewers in a viewing area and in response thereto, or in response to a user input, performs desired (predetermined or programmable) functions such as pause playing of content when at least one viewer leaves the viewing area, and continue or resume playing the content when the viewer(s) returns to the viewing area, e.g., when the detected number of current viewers CV in the viewing area is equal to a value N of the original number of viewers stored in a memory of the intelligent system.

According to one exemplary embodiment a system includes a playback device configured to display content on a display. A detector detects a first number N of viewers in a viewing area at the start of the playback device when in the smart mode, where N is stored in a memory of the playback device or a controller thereof, such as a remote controller.

The smart mode may be activated by a user by activating a key on the playback device, the remote controller, or other elements of the system, such as on a TV, set-top box, VCR, CD/DVD player-recorder, other playback devices and the like. Of course, the smart mode may be the default mode, or the playback device may already be in the smart mode in response to a previous activation of the smart mode.

A controller generates a control signal to pause the playback device when a reduced number, e.g., N−1 or less, of current viewers is detected by the detector, indicating that at least one viewer is no longer in the viewing area. The controller generates a further control signal to resume playback of the playback device in response to detecting by the detector that the number of viewers in the viewing area is the original stored number N, indicating that the original number of viewers are present in the viewing area. The playback device may be rewound for a predetermined time in response to the first control signal prior to the pause, or in response to the further control signal.

The stored number N of the original viewers as detected at the start of the playback device may be updated in response to a user input, such as activating a key on the playback device or a controller thereof, such as the remote controller. Alternatively, the stored number N of viewers may be updated automatically upon detection of at least one additional viewer, e.g., upon detection that the number of viewers in the viewing area is at least N+1.

The foregoing features will become more readily apparent and may be understood by referring to the following detailed description of illustrative embodiments of the present invention, taken in conjunction with the accompanying drawings. It should be expressly understood that the drawings are included for illustrative purposes and do not represent the scope of the present invention that is defined by the appended claims. The illustrative embodiments are best understood in conjunction with the accompanying drawings, where:

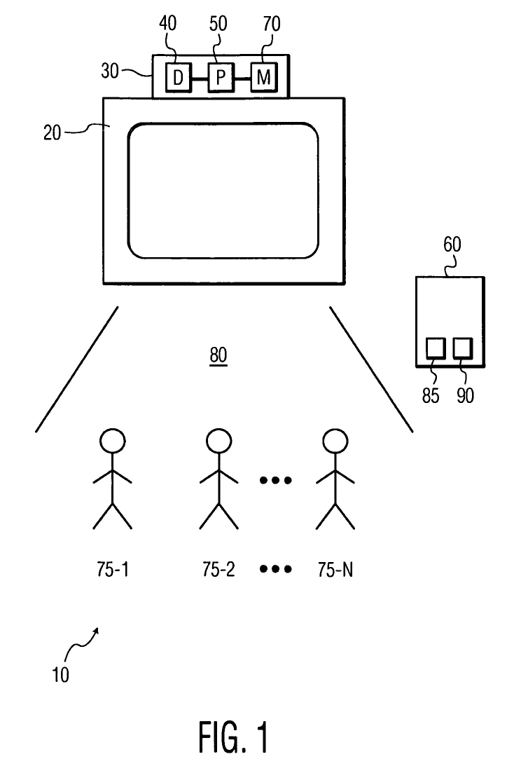

FIG. 1 shows a block diagram of a system according to one embodiment of the present invention; and

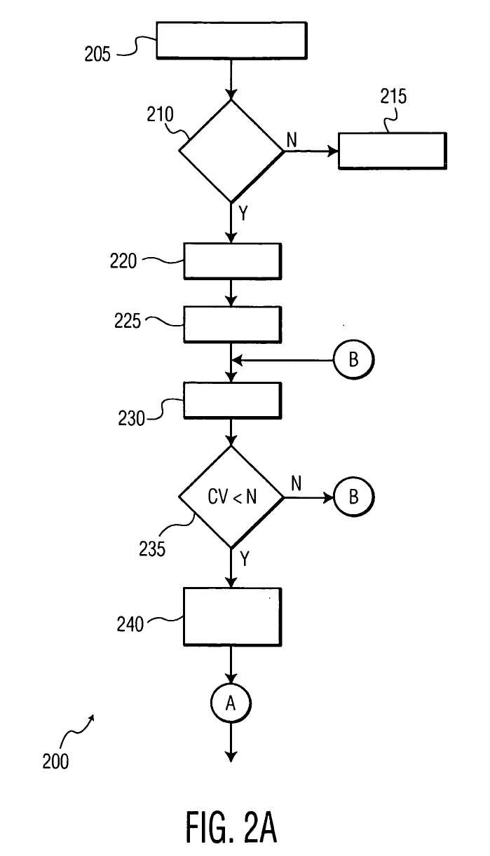

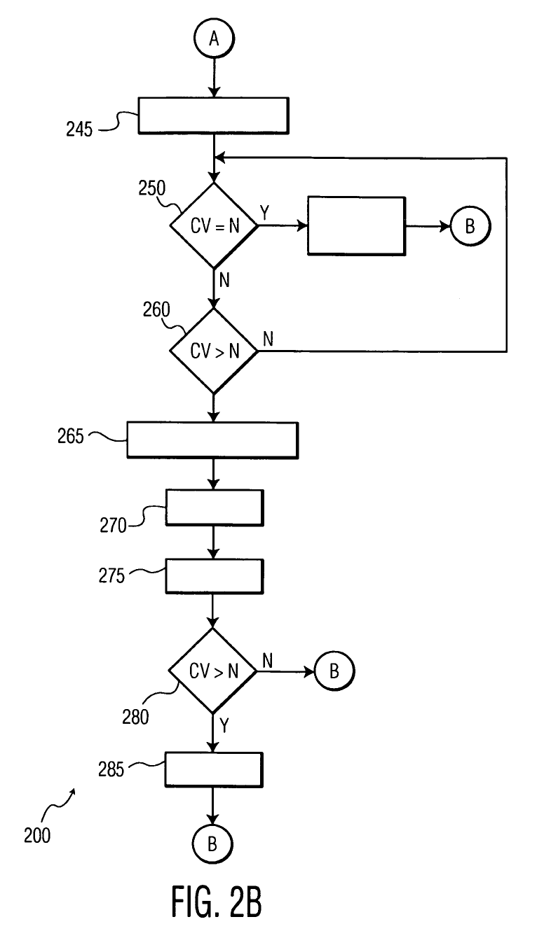

FIGS. 2A-2B show a flow chart of operations according to another embodiment of the present invention.

In the discussion to follow, certain terms will be illustratively discussed in regard to specific embodiments or systems to facilitate the discussion. As would be readily apparent to a person of ordinary skill in the art, these terms should be understood to encompass other similar known terms wherein the present invention may be readily applied. For example, the present invention will illustratively be described with regard to audio/visual content. This system would obviously also be applicable to strictly audio or video content, other content, or a mixture of audio and other types of content. Each of these and any other applicable systems should be understood to be within the scope of the appended claims.

For brevity, various details which are not directly related to the present invention, such as different viewer and content/advertisement detection techniques, are not included herein, but are well known in the art.

In accordance with an exemplary embodiment, FIG. 1 is a block diagram of an entertainment system 10 capable of automatically detecting the number of people watching or listening to a program, such as a video program watched on a television or monitor 20, where the program may be provided from a playback device 30 such as a video cassette, CD or DVD player-recorder or any other devices such as set-top boxes or personal video recorder (PVRs) that may include recommenders, such as those made by Tivo™. Alternatively, the program may be broadcast with pause, rewind, fast-forward, playback and other capabilities, such as via digital or interactive television, in which case the television is deemed to be the playback device.

The entertainment system 10, including for example a video monitor or television 20 and/or the playback device 30, has a detector 40 configured to detect or measure the number N of people 75-N in the room or viewing area 80 watching the program. Illustratively, the detector 40 includes infrared, optical, sonar, video, RF and/or other suitable detector(s) well known in the art. The entertainment system 10 further includes a processor 50 and controller 60 configured to pause or continue playback of the programs based on an algorithm, where an exemplary embodiment is described below.

FIG. 1 shows the detector 40 and processor 50 as part of a stand-alone playback device 30. However, as would be apparent to one of ordinary skill in the art, the detector 40 and processor 50, as well as a memory 70 for storing the number N of viewers 75-N, may be incorporated in other elements, such as incorporated in the television 20 for example, or distributed among the various elements of the entertainment system 10, or may be provided in a separate stand alone unit connectable to the television 20 and/or the playback device 30, for example. Further, the processor may be any suitable type of processor and may be included in whole or in part in the controller 60 or in other elements of the entertainment system 10, or distributed throughout various elements of the entertainment system 10. In the case the detector 40 is an infrared detector, the detector 40 measures the number of warm entities, e.g., persons in the room. The detector 40 is connected to the processor 50 and/or controller 60 of the playback device via wired or wireless connection(s) or channel(s), protocol(s) or bus(es), such as an I²C, bus, a wireless Bluetooth connection, or any other communication links such as IR, RF, optical or sonar links, or other hardware/software links and/or protocol(s).

Imagine that a person or a group of people is, for example, watching a movie on the monitor or television 20 of the entertainment system 10. The movie may be broadcast or provided from the user's playback device 30. Further, the signal source of the program being watched may be any source such as from broadcast or recorded sources received through any medium, such as air, telephone lines, optical fiber, cable and the like. What typically happens is that one of the people or viewers 75-N gets up after a certain time and leaves the viewing area 80 to go to the kitchen for a few minutes, for example. The system according to one embodiment includes a smart-pause mechanism that pauses the playback device 30 without the need to press any button, e.g. on the remote control unit 60 or on the playback device 30. When the person returns to the viewing area 80, the playback device 30 continues playing the movie.

In an illustrative embodiment, at the start of a playback, the detector 40 measures the number N of viewers 76-N in the viewing area 80 of the TV 20 and stores this number N in the memory 70 for future reference. As is well known, different types of memory are used for storage of various data and associated with the processor such as ROM and RAM memory for storing data and operating instructions. During playback, at certain intervals which may be predetermined and/or programmable, such as each second or at random intervals, the detector 40 measures the number N of viewers 75-1, 75-2 . . . 75-N in the viewing area 80. When the number N of viewers 75-N in the viewing area 80 decreases, e.g., to N−1 or less as compared to the original number N stored in the memory 70, the controller 60 pauses the playback and reverse-wind a few seconds for example. When a future detector measurement performed by the detector 40 indicates that the number of viewers 75-N in the viewing area 80 equals N (i.e., the original number of viewers stored in the memory 70), then the playback continues again.

When a person(s) does not return for a certain time period, which may be predetermined and/or programmable, e.g., the measured number of viewers 75-N in the viewing area 80 does not equal the value N stored in the memory 70 for a certain time period, and the rest of the viewers want to continue the paused program, they can overrule the automatic algorithm by pressing the play or pause button on the remote controller 60 or playback device 30. In this way the service e.g., the program, starts continuing. Now, the detector 40 measures the new number of viewers 75-N currently in the viewing area 80 and this new number is stored in the memory 70 as a new N for a future reference.

When during the playback the number of number of viewers 75-N in the viewing area 80 exceeds N, because someone new joins the other viewers in the viewing area, a new number N that equals the current number CV of viewers 75-N in the viewing area 80 is stored in the memory 70 to replace the old stored value N.

The processor 50 is also configured to place the system 10 in the smart mode which may be activated using a separate smart key 85 on the remote controller 60 or the playback device 30, for example. In the smart mode, in response to detecting N−1 or less viewers in the viewing area 80 by the detector 40, the processor 50 is configured to generate a control signal to pause the playback device 30 when a reduced number (e.g., N−1 or less) of viewers is detected by the detector 40 in the viewing area 80, indicating that at least one viewers is no longer in the viewing area.

The controller generates a further control signal to resume playback of the playback device in response to detecting by the detector that the number of viewers in the viewing area is the original stored number N, indicating that the original number of viewers are present in the viewing area. The playback device may be rewound for a predetermined time in response to the control signal prior to the pause.

In another embodiment, the controller may also be configured to detect advertisement in the displayed content and refrain from pausing the playback device when the detected number of viewers is less than the stored number N, until the advertisement is finished. Upon detecting the end of the advertisement, the detector measures the numbers of viewers in the viewing area and pauses the playback device if the detected number of viewers is less than the stored number N.

The detector is configured to periodically detect the viewers in the viewing area, such as every second or some other period of time which need not be periodic and could be random. Illustratively, the detector detects the number of viewers in the viewing area using an optical sensor such as a camera as disclosed in U.S. 2002/0174426 A1 for example, or other sensors such as based on infrared, sonar, or radio wave detection. Of course, the number of viewers may be detected via other means or sensors, such as counting via beam breaking, as disclosed in U.S. Pat. No. 6,712,269 B1 which is incorporated herein by reference in its entirety. For example, two spaced apart beams may be used to detect whether a viewer is entering or leaving the viewing area based on which beam is broken first.

The stored number N of the original viewers as detected at the start of the playback device may be updated in response to a user input, such as activating a key on the playback device or a controller thereof, such as the remote controller. Alternatively, the stored number N of viewers may be updated automatically upon detection of at least one additional viewer, e.g., upon detection that the number of viewers in the viewing area 80 is at least N+1.

Updating the stored number N may be performed upon detecting an additional viewer(s) for a predetermined period of time, e.g., N+1 viewers is detected for approximately one to five minutes or any other desired period or detection cycles, which may be programmable. This prevent such updates of the stored number N when an additional person(s) enters the viewing area temporarily and leaves soon thereafter within the predetermine time or within a certain number of detection cycles. Further, whenever a change in the number of viewers is detected, the detector detects the viewers more frequently than otherwise, such as ten times a second, instead of the normal once a second, for example. The frequency of detection may be variable and programmable. For example, when N−1 viewers are detected, then the frequency is substantially increased, such as ten detections per second, to verify the reduced number of viewer before pausing the playback device. Further, when an increased number of viewers is detected, the frequency of detection may be increased or remain the same, while updating the stored number N with the new number of viewers is performed after detecting at least N+1 viewers for certain period of time which may be predetermined or programmable by a user.

In one embodiment, instead of pausing the playback device 30 when a reduced number (e.g., N−1 or less) of viewers is detected, the processor 50 may be configured to continue playback despite detection of at least one less viewer in the viewing area 80 in the case the content is showing an advertisement or commercial. When the commercial ends, and the newly detected number of viewers is still less than N, then the processor 50 generated the control signal to pause the playback as described above, until the detected number of viewers is N, or an override signal to resume playback is generated in response to a viewer action, such as activation of a resume key.

Advertisement/content may be detected using a variety of methods well known in the art, such as analyzing content, metadata, or other know means, as disclosed in U.S. Provisional Patent Application No. 60/614721 (Attorney Docket No. US040395), WO02/096102 A1 to Trajkovic et al., assigned to Koninklijke Philips Electronics N.V., WO01/35409A2 to Christopher, and US2003/003145A1 to Sagar which are incorporated herein by reference in their entirety. For example, commercial monitoring centers may be used as disclosed in U.S. Pat. No. 6,233,734 B1 to Macrae et al. which is incorporated herein by reference in its entirety.

In another embodiment shown in FIGS. 2A-2B, operation 200 of the intelligent entertainment system includes various operations which may be performed under the control of the processor 50, as is apparent to one skilled in the art. For example, upon the start of playback (operation 205) of a movie or any other content, in operation 210, the processor 50 detects whether the smart mode is entered. If the entertainment system is not in the smart mode, then normal operation 215 of the entertainment system is performed. If the current mode is the smart mode, which may be the default or entered by activation of a smart key (located on any of the elements of the entertainment system) by a viewer, then operation 220 is performed where the detector 40 (FIG. 1) detects the number of viewers N in the viewing area 80. In operation 225, N is stored in the memory 70, which for example may be performed if the value of N is different than the value of what is already stored in memory 70 if any, e.g., as determined by comparing the value stored in the memory 70 with the detected number of viewers.

Next, in operation 230, the detector 40 detects the number of current viewers CV in the viewing area 80 at desired intervals which may be programmable or predetermined. In operation 235, the processor 50 compares the current viewers CV to the value N stored in the memory 70. If the number of current viewers CV detected in operation 230 is not less than the stored value N, then the method returns to operation 230 for further detection of current viewers CV. If the number of current viewers CV detected in operation 230 is less than the stored value N, then operation 240 is performed.

Of course, as is apparent to one skilled in the art, other comparisons may be performed such as returning to operation 230 when the current viewers CV is equal and/or greater then the stored value N, and proceed to operation 240 when the current viewers CV is less then the stored value N.

In operation 240, the processor 50 provides a command or control signal to pause the playback device 30 to stop playback of the viewed program. Optionally, prior to pausing, the playback device 30 may be rewind for a desired (e.g., predetermined or programmable) interval. Next as shown in operation 245, the detector 40 detects the current viewers CV in the viewing area 80, which is compared to the value N stored in the memory 70 in operation 250. If the detected current viewers CV is equal to the stored value N, then the playback of the playback device 30 is continued in operation 255, and the detector continues to detect the current number of viewers, such as by returning to operation 230.

If the result of the comparison in operation 250 indicates that the detected current viewers CV in the viewing area 80 is not equal to the value N stored in the memory 70, then a comparison 260 is performed to determine whether the detected current viewers CV is greater than the stored value N. Of course, one skilled in the art can readily see that the comparison could also be whether the detected current viewers CV is less than the stored value N with adjustments in the following operations to achieve the following desired results. If the detected current viewers CV is not greater than the stored value N, then operation is returned to detect the current viewers CV, such as to operation 245. If the detected current viewers CV is greater than the stored value N, then the processor 50 send a command or control signal to the playback device to resume playback as shown in operation 265. Next, operation 270 provides a predetermined or programmable delay. It should be noted, for example, that anytime the detector 40 detects that the current viewers CV is greater than the stored value N, then the method proceeds to operation 270 and the following operation as described below.

After the delay in operation 270 is performed, the detector 40 again detects the current number of viewer CV in the viewing area 80 as shown in operation 275. In operation 280, the detected current number of viewers CV is compared with the stored value N and if not greater, then the detection cycle continues, such as by returning to operation 230. Otherwise, the new (or greater than N) value of current viewers CV is stored in the memory 70. Thus, when a new viewer(s) joins the rest of the viewers in the viewing area, the current number of viewers stored in memory 70 is updated with the new number of viewers, as shown in operation 285. The delay in operation 270 prevents updating the stored value in memory 70 when a new viewer(s) joins the group for a short time and leaves thereafter. Of course, the current number of viewer CV may be stored in the memory 70 in response to a user input, such as depressing a key 90 on the controller 60, or the quickly depressing multiple times the smart-mode key 85, or any other means that is apparent to one skilled in the art, such as depressing the play key on the remote controller or playback device. Further, any key or means that activates storage of the current viewers in the memory 70 may be located alternately or additionally on one or more elements of the entertainment system 10.

As is readily apparent to one skilled in the art, instead of the delay in operation 270, operation 280 is performed after it is determined that, for a desired interval, the current number of viewer CV in the viewing area 80 is greater than the stored value N, where the detector 40 detects during this desired interval, e.g., after a desired number of detection cycles (which may be programmable), that the detected current number of viewers remains greater then the stored value N.

Finally, the above-discussion is intended to be merely illustrative of the present invention and should not be construed as limiting the appended claims to any particular embodiment or group of embodiments. Numerous alternative embodiments may be devised by those having ordinary skill in the art without departing from the spirit and scope of the following claims. For example, although the processor 50 is shown as included in the playback device 30, the processor 50 may be in the TV 20 or controller 60, or distributed throughout the controller 60, playback device 3020, TV 20 and/or other elements. Further, the processor 50 may be a dedicated processor for performing operations in accordance with the present invention, or may be a general-purpose processor wherein some of its many functions operate for performing in accordance with the present invention. The processor may operate utilizing a program portion, multiple program segments, or may be a hardware device utilizing a dedicated or multi-purpose integrated circuit.

Further, the content may be a broadcast signal or prerecorded and played back locally. For example, the input signal may come from a DVD-recorder, e.g., having hard disc. Thus, the processor 50 is configured to recognize the playback device that is playing the content, and to control that playback device.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A system (10) comprising:
a playback device (30) configured to display content on a display;
a detector (40) configured to detect a first number of viewers in a viewing area; and
a controller (60) configured to generate a control signal to pause said playback device (30) when a reduced number of said viewers is detected by said detector (40).

2. The system (10) of claim 1, wherein said controller (60) generates a further control signal to resume playback of said playback device (30) in response to detecting said number of said viewers in said viewing area by said detector (40).

3. The system (10) of claim 1, wherein said playback device (30) is rewound for a predetermined time in response to said control signal prior to said pause.

4. The system (10) of claim 1, wherein said detector (40) is configured to periodically detect said viewers in said viewing area.

5. The system (10) of claim 1, wherein said first number of viewers is stored in a memory (70).

6. The system (10) of claim 5, wherein a new number of viewers is stored in said memory (70) in response to one of a user input and detection of said new number for a predetermined period of time.

7. The system (10) of claim 5, wherein a new number of viewers is stored in said memory (70) in response to detecting said new number, said new number being greater than said first number.

8. The system (10) of claim 8, wherein a new number of viewers is stored in said memory (70) in response to detecting said new number for a predetermined period of time, said new number being greater than said first number.

9. The system (10) of claim 1, wherein said first number of viewers is stored in a memory (70) approximately at beginning of playback of said content.

10. The system of claim 1, wherein said detector (40) detects said viewers in said viewing area using one of a camera, infrared, sonar, and radio waves.

11. A method (200) for pausing and resuming play of a playback device (30) comprising:
detecting (220) a first number of viewers in a viewing area; and
generating (240) a control signal to pause said playback device (30) in response to detecting a reduced number of said viewers.

12. The method (200) of claim 11, further comprising generating (255) a further control signal to resume playback of said playback device (30) in response to detecting said number of said viewers in said viewing area.

13. The method (200) of claim 11, further comprising rewinding said playback device (30) for a predetermined time in response to said control signal prior to said pause.

14. The method (200) of claim 11, wherein said detecting is performed periodically to detect said viewers in said viewing area.

15. The method (200) of claim 11, further comprising storing said first number of viewers in a memory (70).

16. The method (200) of claim 15, further comprising storing (285) a new number of viewers is stored in said memory (70) in response to one of a user input and detection of said new number for a predetermined period of time.

17. The method (200) of claim 15, further comprising storing (285) a new number of viewers is stored in a memory (70) in response to detecting said new number, said new number being greater than said first number.

18. The method (200) of claim 17, further comprising storing (285) a new number of viewers in said memory (70) in response to detecting said new number for a predetermined period of time, said new number being greater than said first number.

19. The method (200) of claim 11, further comprising storing (225) said first number of viewers in a memory (70) approximately at beginning of playback of said playback device (30).

20. A computer program embodied within a computer-readable medium created using the method of claim 11.

21. A controller (60) for a system comprising a processor configured to generate a control signal to pause a playback device (30) when a reduced number of viewers in a viewing area is detected by a detector (40), said reduced number being less than a first number of viewers detected by said detector (40) detected at a previous time.

22. The controller (60) of claim 21, where said previous time is approximately a start of playback of said playback device (30).
